(19) United States
(12) Patent Application Publication
(10) Pub. No.: US 2026/0097933 A1
(43) Pub. Date: Apr. 9, 2026

(54) METHOD FOR DETERMINING A POSITION AND/OR MOVEMENT OF A ROPE

(71) Applicant: Liebherr-Werk Nenzing GmbH, Nenzing (AT)

(72) Inventors: Nicola SCHLATTER, Nenzing (AT); Thomas ROSENBERGER, Feldkirch (AT)

(21) Appl. No.: 19/354,249

(22) Filed: Oct. 9, 2025

(30) Foreign Application Priority Data
Oct. 9, 2024 (DE) 10 2024 129 102.8

(51) Int. Cl. B66C 13/46; G01S 7/48; G01S 17/88; E02F 9/26

(52) U.S. Cl. CPC B66C 13/46; G01S 7/4808; G01S 17/88; E02F 9/264

(57) ABSTRACT

The present disclosure relates to a method for determining a position and/or movement of a rope, in particular of a machine, and/or of a load arranged on the rope, comprising the steps of: determining measurement points by a sensor unit; assigning the measurement points to the rope and/or to the load arranged on the rope; determining the position and/or movement of the rope and/or of the load attached to the rope.

### CROSS REFERENCE TO RELATED APPLICATION

The present application claims priority to German Patent Application No. 102024129102.8 filed on October 09, 2024. The entire contents of the above-listed application are hereby incorporated by reference for all purposes.

### TECHNICAL FIELD

The present disclosure relates to a method for determining a position and/or movement of a rope, in particular of a machine, and/or a load arranged on the rope.

### BACKGROUND

In machines, in particular cranes, with rope-guided loads or rope-guided equipment, movements of the working machine can cause the load or the equipment to swing. Furthermore, during lifting or lowering of loads or equipment, rope skew can occur, in which the course of the rope is not vertical.

### SUMMARY

Rope skew results in a higher load on the structure of the working machine than the load calculated under the assumption of a vertical rope path, for which the structure of the working machine was designed. This can cause damage to the working machine. Rope skew during lifting of loads or equipment can also lead to undesired swinging movements of the load or equipment.

Therefore, various systems for detecting rope skew are known from the prior art.

Known systems are based on sensor technology with an inclination sensor or acceleration sensor suspended from the crane tip through which the rope runs. In the case of rope skew, i.e. a slanted course of the rope, the angle of the rope relative to the vertical axis is determined by means of the sensor and an algorithm. Such systems are known, for example, as Vertical-Line-Finder (VLF) systems and are used, for example, on cranes for material handling and crawler cranes.

For dynamic movements of the rope, in particular on cranes for material handling, the LPO system is also used. This system has a comparable mechanical setup to the VLF system. Instead of acceleration sensors, gyroscopes are used to better account for dynamic effects on the sensor measurement values and thus enable more accurate measurement. Such systems are also known as Cycoptronic.

However, the known systems and methods require complex sensor technology.

Against this background, the object of the present disclosure is to improve the above-mentioned method.

This object is achieved by a method having the features as described herein.

According to the disclosure, the method comprises the steps of:

determining measurement points by a sensor unit;

assigning the measurement points to the rope and/or to the load arranged on the rope;

determining the position and/or movement of the rope and/or the load attached to the rope.

The method may be a computer-implemented method.

The rope may also comprise several rope sections or ropes. In other words, the position and/or movement of several ropes can be determined.

The measurement points may be determined by 3D distance measurement, for example by means of a lidar.

It may be provided that the sensor unit is a lidar or comprises a lidar and/or is arranged in particular on the machine.

Optionally, the assignment is performed by segmenting the measurement points, in which the measurement points are divided into categories and assigned to the rope, the load, the equipment, and/or other objects.

The measurement points may also be referred to as coordinates. The sensor unit may also be referred to as a measuring unit.

In other words, the sensor unit can detect coordinates, for example relative to the sensor unit, which correspond to real points on objects in the detection range of the sensor unit.

Segmentation of the measurement points optionally includes a coarse segmentation, in which measurement points that are likely to be assigned to the rope(s) and the equipment are identified.

Segmentation of the measurement points optionally includes extracting geometric primitives from the measurement points that represent the rope(s) and characteristic parts of the load. Optionally, a minimum bounding rectangle or a bounding box is used to estimate the initial position of the load.

Segmentation of the measurement points optionally includes a fine segmentation of the measurement points to be assigned to the rope(s). In the measurement points of the coarse segmentation, measurement points are optionally searched for that correspond to a rope model or line model. The fine segmentation can be carried out, for example, by means of a Random Sample and Consensus (RANSAC) algorithm and/or rope models.

Segmentation of the measurement points optionally also includes fine segmentation of the measurement points to be assigned to the equipment.

Segmentation, in particular coarse and/or fine segmentation, can be carried out using an Iterative-Closest-Point (ICP) algorithm and/or a Kalman filter.

Optionally, during the assignment, coarse segmentation of the measurement points is performed, in which measurement points are identified as measurement points likely belonging to the rope and/or as measurement points likely belonging to the load arranged on the rope.

Optionally, during the assignment, fine segmentation of the measurement points is performed, in which measurement points are identified as measurement points belonging to the rope and/or as measurement points likely belonging to the load attached to the rope.

Optionally, fine segmentation is carried out using a RANSAC algorithm and/or a rope model.

Optionally, the position of the rope comprises or is a rope angle and/or the position of the load attached to the rope comprises or is an orientation of the load attached to the rope.

Optionally, one or more rope angles relative to the sensor unit are determined.

Optionally, determining the position and/or movement of the rope and/or of the load attached to the rope takes place relative to the position of the sensor unit.

Optionally, the determined position of the rope and/or the load attached to the rope is subjected to one or more coordinate transformations.

The determined rope angle(s) and/or the position and/or orientation of the equipment can be transformed into other coordinates. For example, it is conceivable, taking machine kinematics into account, to transform the measurement values, in particular measurement points, into another body-fixed coordinate system of the machine.

It is also conceivable, taking into account the orientation of the sensor unit relative to earth acceleration or the vertical, to transform the measurement values, in particular measurement points, into a space-fixed coordinate system. This transformation is required, for example, to determine rope skew relative to the vertical.

Optionally, the load is a rope-guided piece of equipment, for example a diaphragm wall grab or diaphragm wall cutter. The equipment may be a clamshell bucket.

Optionally, determining the position and/or movement of the load attached to the rope is carried out only using measurement points assigned to the rope, in particular when the load and/or a part of the rope is not or not fully in the detection range of the sensor unit.

Optionally, the sensor unit is used to determine further information, in particular about an environment, in particular of the machine.

The disclosure also relates to a system with means for carrying out a method according to the disclosure, the means comprising a sensor unit.

The disclosure also relates to a machine with a system according to the disclosure.

The machine is optionally a crawler crane, a rope excavator, a tower crane, a ship crane, a harbor crane, a harbor mobile crane, an offshore crane, a fast-erecting crane, or a truck crane. The system can be part of one or more of these machines. The machine may be a crane.

The method is optionally used for determining the position and/or movement of a rope-guided piece of equipment. The load is optionally equipment, e.g. a diaphragm wall grab or a diaphragm wall cutter. Optionally, the position and/or orientation of the equipment is determined relative to the sensor unit.

The method can be used in automated material handling, for example with a harbor crane. The system can be part of a warning and/or alerting system, for example a distance alerting system, in particular for a harbor crane.

Optionally, the position and/or movement of the rope and/or the load arranged on the rope is displayed on a screen. Optionally, information about the position of the load arranged on the rope, for example a hook, above the ground can be overlaid on a live image for an operator at a remote control station of the machine, e.g. a crane, e.g. a tower crane.

The position, velocity, and/or orientation of the load during dynamic movement of the load, e.g. during material handling, may be important parameters for automation of the movement of the crane or the load. These parameters are required, for example, to control and/or regulate the movement of the crane and/or the load when a load is to be moved to a specific location.

Optionally, the method is used for monitoring rope skew. In this case, monitoring of a deviation from a nominal position of the rope and/or the load arranged on the rope is carried out. For example, when operating a diaphragm wall grab or a diaphragm wall cutter, it is required that the created trench follows a vertical course as precisely as possible. If rope skew is measured, this means that the diaphragm wall grab or diaphragm wall cutter deviates from the vertical course and/or is itself not vertical, so that the resulting trench will deviate from a vertical course.

The advantage of determining the rope angle(s), compared with merely determining the position of the equipment, is that an estimate of the position of the equipment is possible even when the sensor unit’s field of view is obscured. An obscured field of view may occur, for example, when the equipment is lowered into a hole, such as a diaphragm wall or a ship’s hull, or when the equipment is underwater, such as with a clamshell bucket. The equipment is then, for example, no longer within the detection range of the sensor unit.

In contrast to systems known from the prior art, such as the VLF or LPO system for measuring a rope angle, the installation effort for the sensor unit in the method or system according to the disclosure is lower.

In particular, in a crawler crane, the installation effort of the VLF system is disadvantageous, since for these systems the sensor technology known from the prior art is attached to the rope, requiring increased installation effort on the construction site.

An advantage of the technology according to the disclosure over the VLF and/or LPO system or similar systems is that the same sensor unit can provide further information beyond detection of rope skew. For example, information about the environment of the machine, such as obstacles, can be determined. In this way, the same sensor unit can thus be used multiple times. The system may be a self-contained measuring system and may not depend on other systems. The measurement values, in particular in the form of measurement points, may be traced back to the self-contained system. In this way, the effort of relating and/or calibrating different systems with one another is thus eliminated.

At this point, it is noted that the terms “a” and “an” do not necessarily refer to exactly one of the elements, although this is a possible embodiment, but may also designate a plurality of the elements. Likewise, the use of the plural also includes the presence of the element in the singular, and vice versa, the singular also encompasses several of the relevant elements. Furthermore, all features of the disclosure described herein can be combined with one another in any way or claimed separately.

### BRIEF DESCRIPTION OF THE FIGURES

Further advantages, features, and effects of the present disclosure result from the following description of embodiments with reference to the figures, in which identical or similar parts are designated by the same reference numerals. The figures show in:

FIG. 1, FIG. 2, FIG. 3, and FIG. 4: a sketched front view and a sketched side view of a machine with an embodiment of a system according to the disclosure.

FIG. 5 and FIG. 6: a sketched front view and a sketched side view of a machine.

### DETAILED DESCRIPTION

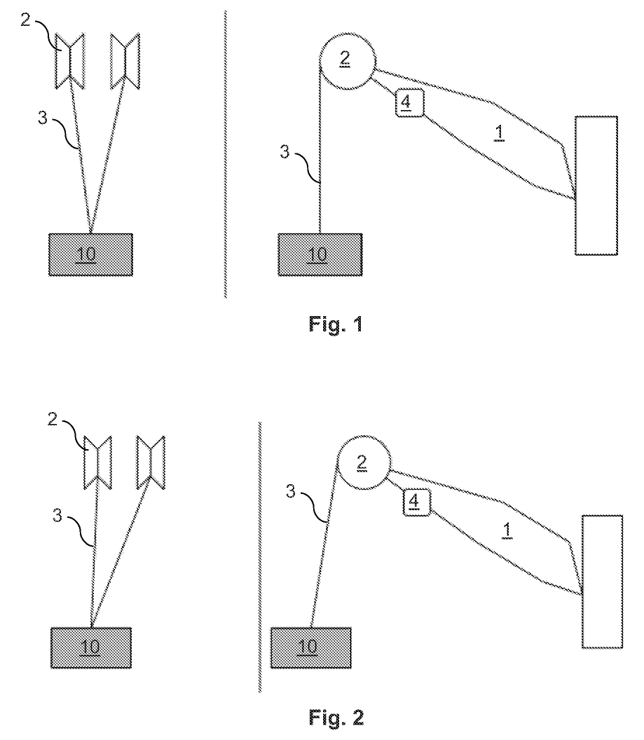

The machine shown in FIGS. 1 to 4 in the form of a crane comprises a boom 1, two rope pulleys 2, and a rope 3, which may also comprise several ropes or consist of several ropes.

A sensor unit 4 in the form of a lidar is arranged on the boom 1 of the machine. The sensor unit 4 has a detection range and is arranged in such a way that the rope 3 and the load 10 are in the detection range, provided the rope 3 or the load 10 are not obscured.

A load 10 in the form of a rope-guided piece of equipment is arranged on the rope 3.

In FIG. 1, a nominal position of the load 10 is shown. The load 10 arranged on the rope 3 in the form of rope-guided equipment is located vertically below the rope exit points on the rope pulleys 2.

The sensor unit 4 is mounted on the boom so that the sensor unit 4 has the rope-guided equipment as much as possible in its field of view from above, i.e. without obstruction. The load 10 or the rope-guided equipment is therefore in the detection range of the sensor unit 4.

In FIG. 2, the load 10 in the form of rope-guided equipment is deflected, i.e. not in the nominal position. A deflection can occur in the direction of the boom 1 and/or laterally. Causes for the deflection may be mechanical (e.g. ground contact, lateral forces, or support) or dynamic (e.g. rotational movement of the machine). The method can determine the deflection. In FIG. 2, the rope 3 thus exhibits rope skew.

In FIGS. 3 and 4, the measuring principle of the method is illustrated. The rope 3 in FIGS. 3 and 4 also exhibits rope skew.

The sensor unit 4 measures distances in certain defined directions. The measured distances and associated directions produce a three-dimensional point cloud of measurement points, where the black points in FIGS. 3 and 4 are measurement points of the rope 3 and the lighter (gray) points in FIGS. 3 and 4 are measurement points of the load 10 or the equipment.

In FIG. 4, the dashed line represents the boundary of the detection range of the sensor unit 4. If no measurement points on the rope-guided equipment are detected, for example due to obstruction and/or immersion of the load 10 in water, whereby the load 10 or equipment is at least partially not in the detection range of the sensor unit 4, as illustrated in FIG. 4, the measurement points of the rope 3 can be used with a rope model, taking into account the rope length issued, to determine and/or estimate the position of the load 10 in the form of the rope-guided equipment.

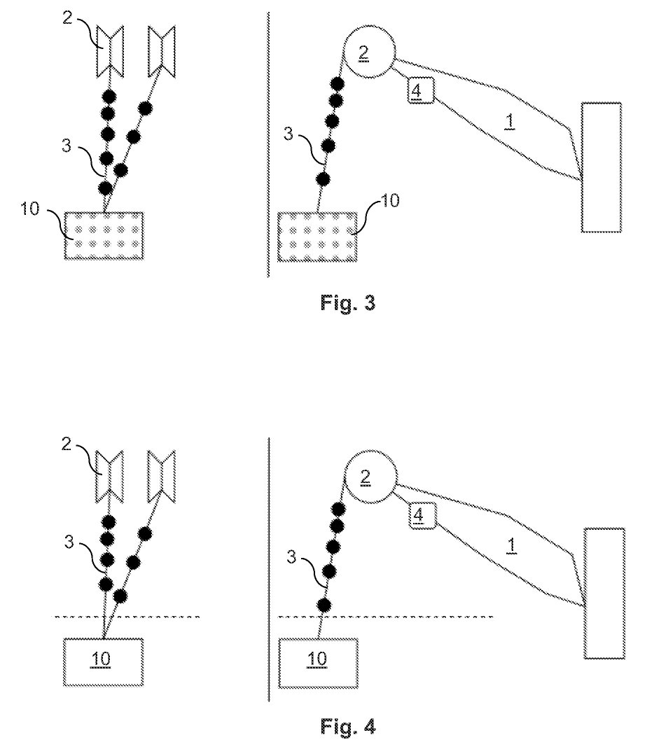

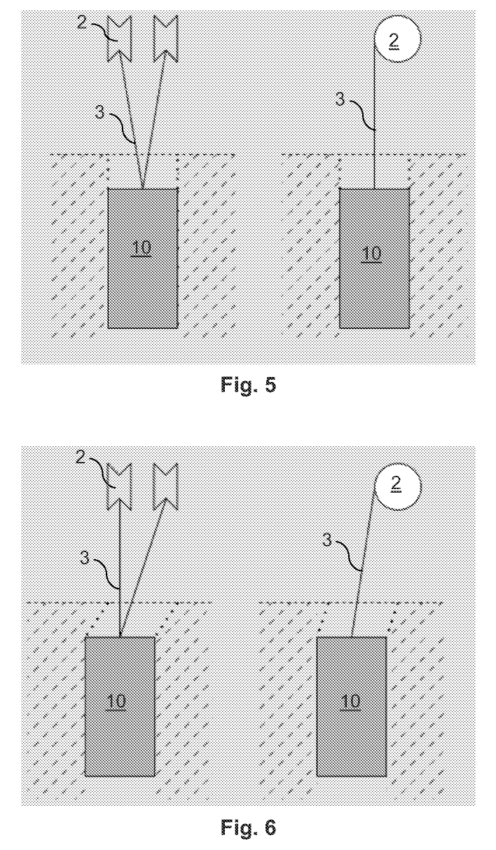

FIGS. 5 and 6 show a load 10 in the form of a diaphragm wall grab or diaphragm wall cutter, which is arranged on a rope 3 guided over rope pulleys 2.

In FIG. 5, the load 10 is vertically below the rope pulleys 2 and the rope 3 is vertical, i.e. aligned without horizontal offset from the vertical. The load 10 is thus in a nominal position.

In FIG. 6, the rope 3 exhibits rope skew.

The diaphragm wall grab or diaphragm wall cutter thus has a lateral offset after a few meters underground, as shown in FIG. 6.

By determining the rope angles, this offset can be detected. Detection of rope skew or offset can be used, for example, to alert an operator to the offset and/or to perform a dedicated measurement run using one or more inertial sensors that may be arranged on or in the diaphragm wall grab or diaphragm wall cutter.

The current measuring technology using inertial sensors of the diaphragm wall grab or diaphragm wall cutter can detect tilting well. However, this measuring technology requires dedicated measurement runs to detect horizontal offset. The method according to the disclosure can be used to monitor the horizontal offset.

1. A method for determining a position and/or movement of a rope and/or of a load arranged on the rope, comprising the steps of:
determining measurement points by a sensor unit;
assigning the measurement points to the rope and/or to the load arranged on the rope; and
determining the position and/or movement of the rope and/or of the load attached to the rope.

2. The method according to claim 1, wherein the sensor unit is a lidar or comprises a lidar.

3. The method according to claim 1, wherein assigning the measurement points to the rope and/or to the load arranged on the rope comprises carrying out coarse segmentation of the measurement points, wherein the measurement points are identified as measurement points likely belonging to the rope and/or as measurement points likely belonging to the load arranged on the rope.

4. The method according to claim 1, wherein assigning the measurement points to the rope and/or to the load arranged on the rope comprises carrying out fine segmentation of the measurement points, wherein the measurement points are identified as measurement points likely belonging to the rope and/or as measurement points likely belonging to the load attached to the rope.

5. The method according to claim 4, wherein the fine segmentation is carried out using a RANSAC algorithm and/or a rope model.

6. The method according to claim 1, wherein the position of the rope comprises or is a rope angle and/or the position of the load attached to the rope comprises or is an orientation of the load attached to the rope.

7. The method according to claim 1, wherein determining the position and/or movement of the rope and/or of the load attached to the rope takes place relative to the position of the sensor unit.

8. The method according to claim 1, wherein the determined position of the rope and/or of the load attached to the rope is subjected to one or more coordinate transformations.

9. The method according to claim 1, wherein the load is a rope-guided piece of equipment.

10. The method according to claim 1, wherein determining the position and/or movement of the load attached to the rope is carried out only using measurement points assigned to the rope.

11. The method according to claim 1, wherein further information is determined by means of the sensor unit.

12. A system with means for carrying out the method according to claim 1, wherein the means comprise a sensor unit.

13. A machine with the system according to claim 12.

14. The method according to claim 1, wherein the rope is arranged on a machine.

15. The method according to claim 2, wherein the lidar is arranged on a machine.

16. The method according to claim 9, wherein the rope-guided piece of equipment is a diaphragm wall grab or a diaphragm wall cutter.

17. The method according to claim 10, wherein the load is and/or part of the rope is not or not fully in the detection range of the sensor unit.

18. The method according to claim 11, wherein the further information is information about an environment of a machine.
